(19) United States
(12) Patent Application Publication
(10) Pub. No.: US 2009/0257730 A1
(43) Pub. Date: Oct. 15, 2009

(54) VIDEO SERVER, VIDEO CLIENT DEVICE AND VIDEO PROCESSING METHOD THEREOF

(75) Inventors: WEN-MING CHEN, Shenzhen City (CN); BANG-SHENG ZUO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/353,930

(22) Filed: Jan. 14, 2009

(30) Foreign Application Priority Data
Apr. 14, 2008 (CN) 200810301131.8

(51) Int. Cl. G04C 13/04

(52) U.S. Cl. 386/52

(57) ABSTRACT

A video server includes a communication unit for receiving a first video signal from a first video client device and a second video signal from a second video client device, an image combination unit for combining the first video signal and the second video signal to generate a combined video signal, and an image frame extracting unit for extracting a combined image frame from the combined video signal in response to a grab command received from one of the first video client device and the second video client device, and sending the extracted combined image frame to the one of the first video client device and the second video client device via the communication unit. A related client device and a video processing method are also provided.

### BACKGROUND

1. Technical Field

Embodiments of the present disclosure relate to video systems, and particularly to a video system including a video server, at least two video clients, and a video processing method of the video system.

2. Description of Related Art

Group photos are taken when people are together. However, graphics editing software, such as Adobe Photoshop®, can be used to create a photo collage to simulate a group photo, but it is complicated and time consuming.

Video systems can transmit video signals representing images (also known as video frames) between two video clients, such that the clients can see images of each other. However, the two users may want to have a group photo but because they are spatially apart they may not be able to have their photo taken together.

Therefore, an improved video server, a video client device, and a video processing method are needed to address the limitations described.

### BRIEF DESCRIPTION OF THE DRAWINGS

FIG. 1 is a schematic diagram of a video system in accordance with an exemplary embodiment.

FIG. 2 is a block diagram of the video system of FIG. 1 in accordance with an exemplary embodiment, the video system includes a first video client device having a display unit.

FIG. 3 is a schematic diagram of the display unit of FIG. 2, the display unit shows three combining templates.

FIGS. 4a-4c are schematic representations of a background change process for a combined image in accordance with an exemplary embodiment.

FIG. 5 is a block diagram of a video system in accordance with an exemplary embodiment.

FIG. 6 is a block diagram of a video system in accordance with an exemplary embodiment.

FIG. 7 is a flowchart of a video processing method in accordance with a first exemplary embodiment.

FIG. 8 is a flowchart of a video processing method in accordance with a second exemplary embodiment.

FIG. 9 is a flowchart of a background change method in accordance with an exemplary embodiment.

FIG. 10 is a flowchart of a video processing method in accordance with a third exemplary embodiment.

### DETAILED DESCRIPTION OF THE EMBODIMENTS

Reference will now be made to the drawings to describe certain inventive embodiments of the present disclosure.

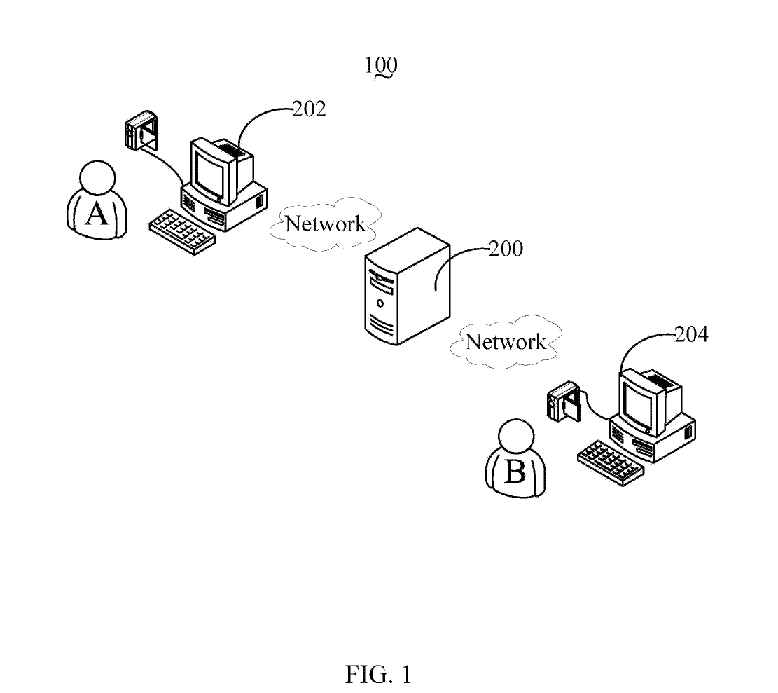

Referring to FIG. 1, a video system 100 includes a video server 200, a first video client device 202, and a second video client device 204. The first and second video client devices 202, 204 are capable of communicating with each other via the video server 200. The first and second video client devices 202, 204 may be computers, mobile phones, etc. which have cameras for capturing real time images (also known as video frames) to generate video signals. The video server 200 is capable of combining video signals generated by the first and second video client devices 202, 204 to generate a combined video signal.

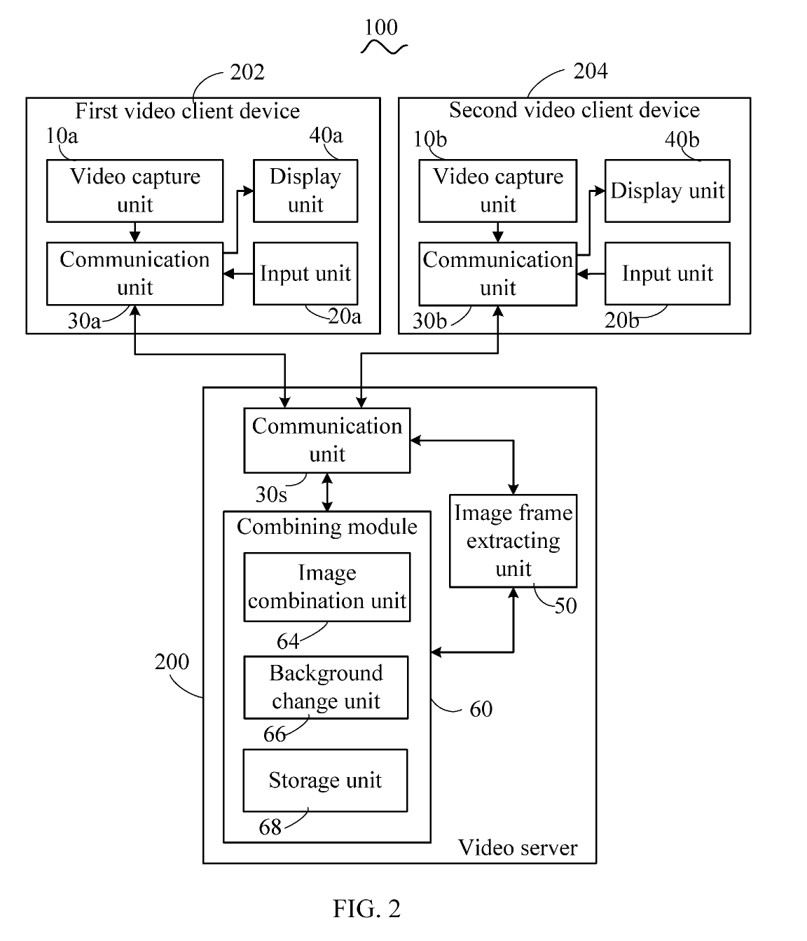

Also referring to FIG. 2, the first video client device 202 includes a video capture unit 10a, an input unit 20a, a communication unit 30a, and a display unit 40a. The second video client device 204 includes a video capture unit 10b, an input unit 20b, a communication unit 30b, and a display unit 40b similar to the video capture unit 10a, the input unit 20a, the communication unit 30a, and the display unit 40a of the first video client device 202, respectively.

The video capture unit 10a is configured for generating a first video signal of a local object, such as a user of the first video client device 202, and sending the first video signal to the video server 200 via the communication unit 30a.

The second video client device 204 operates the same as the first video client device 202 to generate a second video signal of a local object, such as a user of the second video client device 204, using the video capture unit 10b.

The input units 20a/20b receives instructions from the respective user. The instructions may include a combining command for signaling the video server 200 to generate the combined video signal when both the first and second video signals are present, a background change command for signaling the video server 200 to change the background of the combined video signal, and a grab command for signaling the video server 200 to extract a combined image frame from the combined video signal.

The display unit 40a/40b is used for displaying information viewable to the user, such as image frames from the first and second video signals and the combined image frame.

The video server 200 includes a communication unit 30s, an image frame extracting unit 50, and a combining module 60. The combining module 60 includes an image combination unit 64, a background change unit 66, and a storage unit 68.

The image combination unit 64 is configured for combining the first video signal and the second video signal to generate the combined video signal including combined image frames in response to the combining command received from the first or second video client device 202 or 204. A combined image frame includes at least a part of a first image frame and at least a part of a second image frame. Such that each combined image frame looks as if members of the group are actually together for the photo.

In normal operation, the video server 200 receives the first and second video signals via the communication units 30a, 30b, sends the first video signal to the second video client device 204, and sends the second video signal to the first video client device 202. When the video server 200 receives the combining command, the video server 200 generates the combined video signal, and sends the combined video signal to the first or second video client device 202 or 204 which sends the combining command, such that the combined video signal can be displayed on the appropriate display unit 40a or 40b. In other embodiments, the combined video signal may be sent to both the first and second video client devices 202, 204, such that the combined video signal can be displayed on both the display units 40a, 40b.

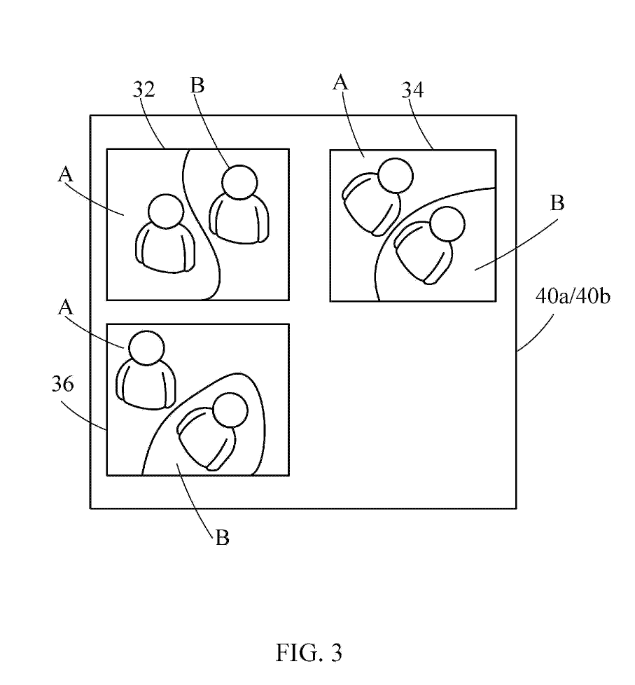

The combined video signal may be generated according to a predetermined combining template. The combining template is used for instructing the image combination unit 64 how to combine the first and second video signals. In this embodiment, the storage unit 68 stores a plurality of combining templates. In operation, the video server 200 may send the plurality of combining templates stored in the storage unit 68 to the first or second video client device 202, 204, and the plurality of combining templates are displayed on the display unit 40a/40b. For example, referring to FIG. 3, three combining templates 32, 34 36 are shown on the display unit 40a. Part “A” in each of the three combining templates 32, 34 36 represents a part of the first image frame, and part “B” represents a part of the second image frame. When one of the three combining templates 32, 34 36 is clicked, the combining command including information corresponding to the one of the three combining templates 32, 34 36 is generated and sent to the video server 200. Then the image combination unit 64 combines the first and second video signals according to the combining command.

The background change unit 66 is configured for replacing a predetermined part of each of the combined image frames with a predetermined picture stored in the storage unit 68. By replacing the predetermined part of each of the combined image frames with the predetermined picture, the combined video may look more natural as if members of the group are actually together for the video. In this embodiment, the predetermined part of each of the combined image frames has the same color information, and is considered as a background. The predetermined part of each of the combined image frames is replaced by a corresponding part of the predetermined picture.

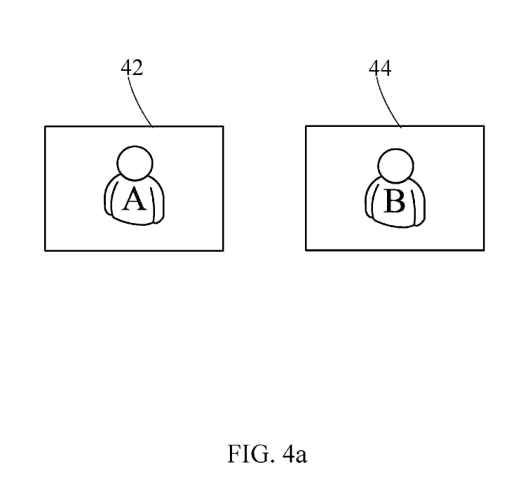

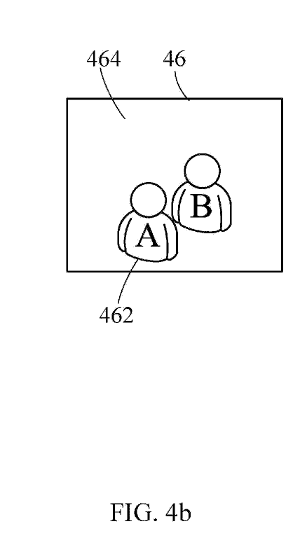

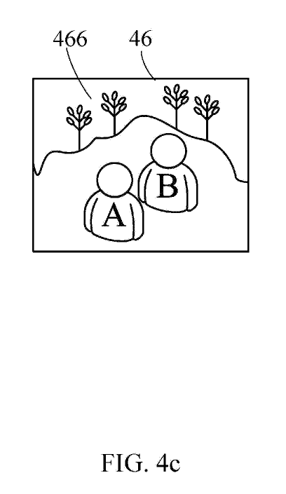

Hereinafter, a background change process for a combined image will be described. Referring to FIG. 4a, picture 42 represents a first image frame, and picture 44 represents a second image frame. In this embodiment, both the pictures 42, 44 have a white background (each pictures shows a user and a white wall, for example). Referring to FIG. 4b, picture 46 represents one of the combined image frames generated by combining the first and second image frames. Part 462 in the picture 46 represents objects, and the blank part 464 having the same color information (white for example) represents the background (the predetermined part). Referring to FIG. 4c, the blank part 464 in the picture 46 has been replaced by a picture 466 of trees. All the combined image frames are processed in the same way.

In this embodiment, the storage unit 68 may also stores a plurality of background pictures. In operation, when the combined video signal is generated and displayed on the display unit 40a, the video server 200 may send the plurality of background pictures (maybe shown as icons) and a color selection dialog box to the first video client device 202. When one of the background pictures and a color are selected, a background change command, including information corresponding to the selected background picture and the selected color information, is generated and sent to the video server 200. Then the background change unit 66 replaces parts having the selected color information of the combined image frames with the selected background picture.

The image frame extracting unit 50 is configured for extracting a combined image frame from the combined video signal in response to the grab command received from the first or second video client devices 202 or 204, and sending the extracted combined image frame to the first or second video client device 202 or 204 which sends the grab command via the communication unit 30a or 30b. As a result, the extracted combined image frame, i.e. a group photo of the two users, is obtained and displayed on the display unit 40a or 40b. In other embodiments, the extracted combined image frame is also sent to the other of the first and second video client devices 202, 204.

To sum up, when the two users have a video chat using a real time communication system, such as Windows Live Messenger®, on the video system 100, they can conveniently create a combined image to imitate a group photo using the video server 200. By posing as desired, then selecting the combining template and changing the predetermined part of the combined video signals, the combined image can be very realistic.

In other conditions, the image frame extracting unit 50 may be disposed in both of the first and second video client devices 202, 204, but not on the video server 200.

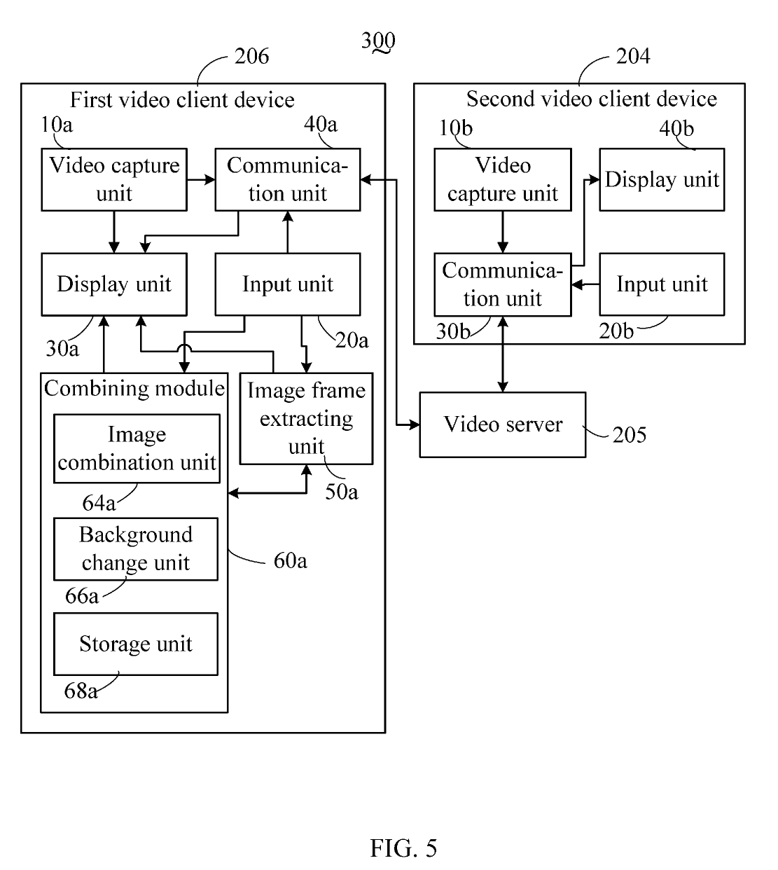

In other conditions, the combining module 60 and the image frame extracting unit 50 may be disposed in one of the first and second video client devices 202, 204. For example, referring to FIG. 5, a video system 300 in accordance with a second embodiment is illustrated. The video system 300 includes a video server 205, a first video client device 206, and the second video client device 204. When compared with the video server 200, the video server 205 is only used for transmitting information between the first and second video client devices 206, 204. When compared with the first video client device 202, the first video client device 206 includes a combining module 60a and an image frame extracting unit 50a, functions of which are similar to the combining module 60 and the image frame extracting unit 50 of FIG. 2. The combining module 60a includes an image combination unit 64a, a background change unit 66a, and a storage unit 68a, functions of which are similar to the image combination unit 64, the background change unit 66, and the storage unit 68 of FIG. 2.

Under this condition, only the first video client device 206 can generate the combined video signal and extract the combined image frame. The combined video signal may be exclusively displayed on the display unit 40a, in other words, the combined video signal will not be sent to the second video client device 204.

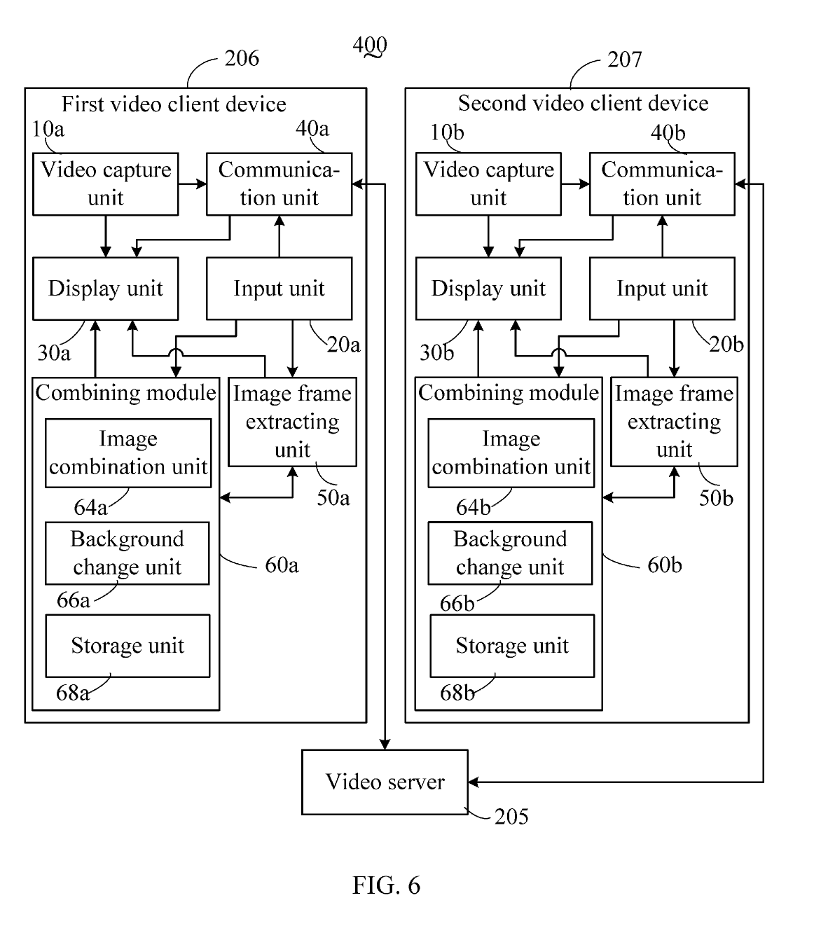

Understandably, the combining module 60 and the image frame extracting unit 50 may be disposed in both the first and second video client devices 202, 204. For example, referring to FIG. 6, a video system 400 in accordance with a third embodiment is illustrated. The video system 400 includes the video server 205, the first video client device 206, and a second video client device 207. When compared with the video system 300 of FIG. 5, the second video client device 207 includes a combining module 60b and an image frame extracting unit 50b, functions of which are similar to the combining module 60a and the image frame extracting unit 50a of FIG. 5. The combining module 60b includes an image combination unit 64b, a background change unit 66b, and a storage unit 68b, functions of which are similar to the image combination unit 64a, the background change unit 66a, and the storage unit 68a of FIG. 5.

Under this condition, the first and second video client devices 206, 207 can generate different combined video signals using different combining templates, and can capture different combined image frames.

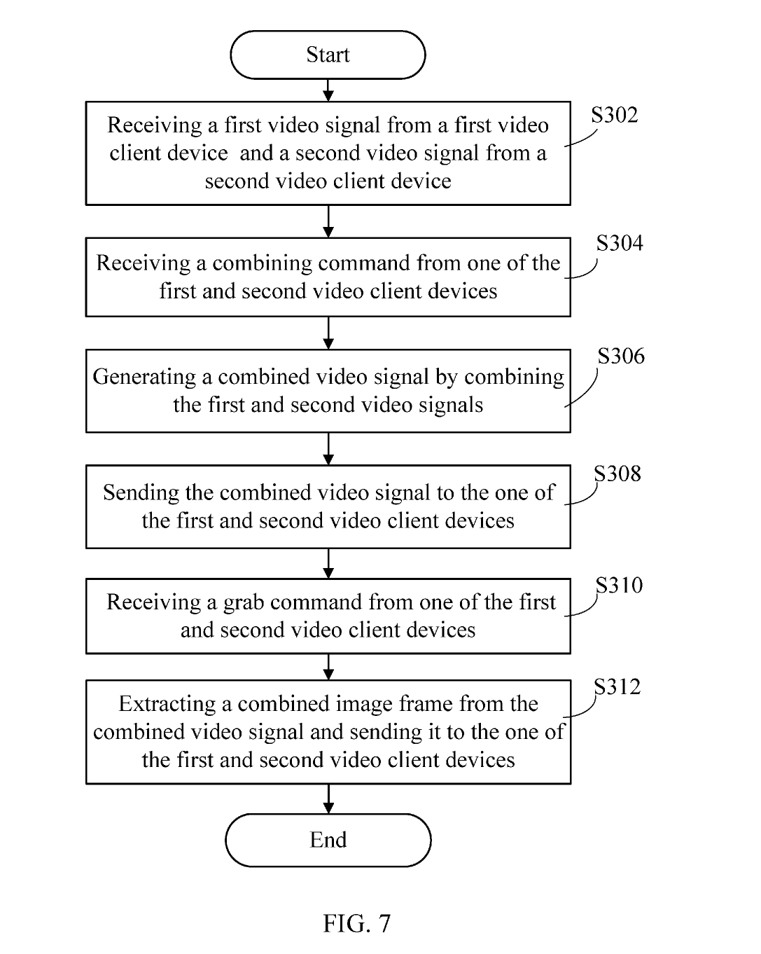

Referring to FIG. 7, a video processing method for a video system, such as the video system 100, in accordance with a first exemplary embodiment is illustrated. The video processing method includes the following steps.

In step S302, a video server (such as the video server 200) receives a first video signal from a first video client device (such as the first video client device 202) and a second video signal from a second video client device (such as the second video client device 204). The first video signal includes first image frames and is generated by a first video capture unit of the first video client device. The second video signal includes second image frames and is generated by a second video capture unit of the second video client device.

In step S304, the video server receives a combining command from one of the first and second video client devices. The combining command may include combining template information for instructing the video server how to combine the first and second video signals.

In step S306, the video server generates a combined video signal including combined image frames by combining the first and second video signals. Each combined image frame includes at least a part of a first image frame and at least a part of a second image frame.

In step S308, the video server sends the combined video signal to the one of the first and second video client devices. As a result, a display unit of the one of the first and second video client devices displays the combined video signal. In other embodiments, the video server may send the combined video signal to both the first and second video client devices.

In step S310, the video server receives a grab command from one of the first and second video client devices.

In step S312, the video server extracts a combined image frame from the combined video signal, and sends the extracted combined image frame to the one of the first and second video client devices. As a result, the display unit of the one of the first and second video client devices displays the extracted combined image frame. In other embodiments, the video server may send the extracted combined image frame to both the first and second video client devices.

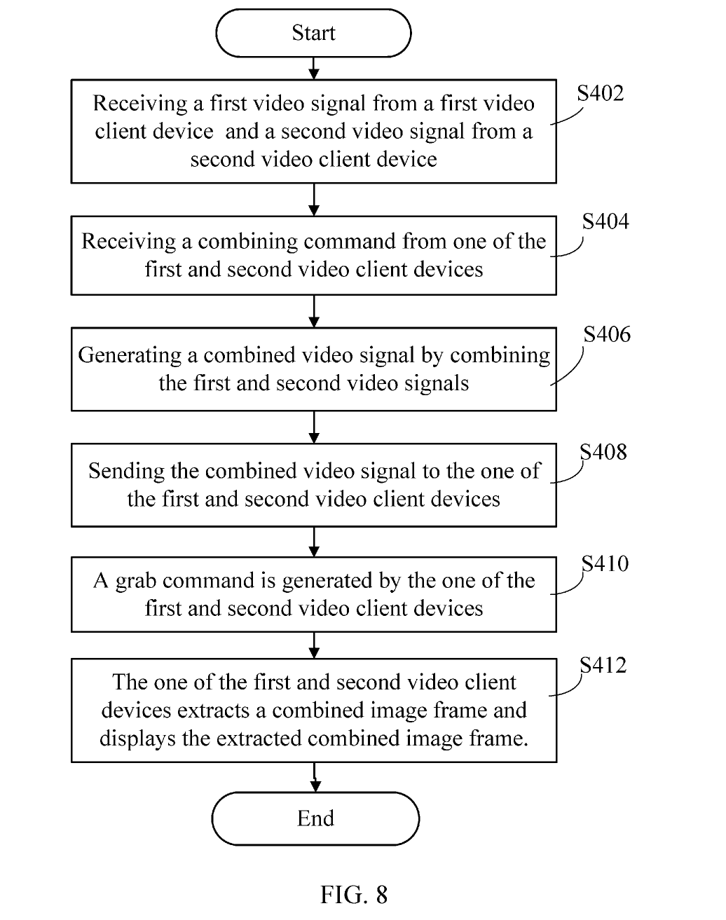

Referring to FIG. 8, a video processing method for a video system in accordance with a second exemplary embodiment is illustrated. The video processing method includes the following steps.

In step S402, a video server receives a first video signal from a first video client device and a second video signal from a second video client device. The first video signal is generated by a first video capture unit of the first video client device. The second video signal is generated by a second video capture unit of the second video client device.

In step S404, the video server receives a combining command from one of the first and second video client devices. The combining command may include combining template information for instructing the video server how to combine the first and second video signals.

In step S406, the video server generates a combined video signal by combining the first video signal and the second video signal. Each of combined image frames from the combined video signal includes at least a part of a first image frame from the first video signal and at least a part of a second image frame from the second video signal.

In step S408, the video server sends the combined video signal to the one of the first and second video client devices, such that a display unit of the one of the first and second video client devices displays the combined video signal. In other embodiments, the video server may send the combined video signal to both the first and second video client devices.

In step S410, a grab command is generated by the one of the first and second video client devices.

In step S412, the one of the first and second video client devices extracts a combined image frame from the combined video signal, and displays the extracted combined image frame.

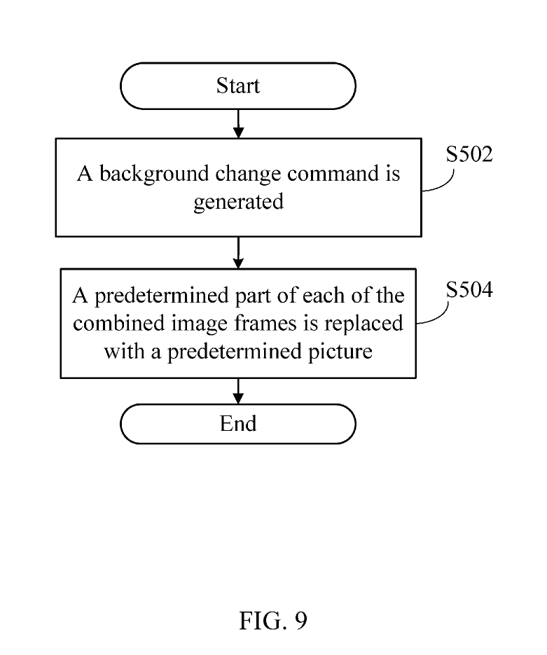

Referring to FIG. 9, a background change method for changing backgrounds of a combined video signal generated by a video system, such as the video system 100, 300, or 400, in accordance with an exemplary embodiment is illustrated. The background change method includes the following steps.

In step S502, a background change command is generated. The background change command includes color information. The color information is used to identify the background of a combined image frame from the combined video signal.

In step S504, a background change unit disposed in one of a video server and a video client device replaces a predetermined part of each of the combined image frames from the combined video signal with a predetermined picture. The predetermined part has a color corresponding to the color information.

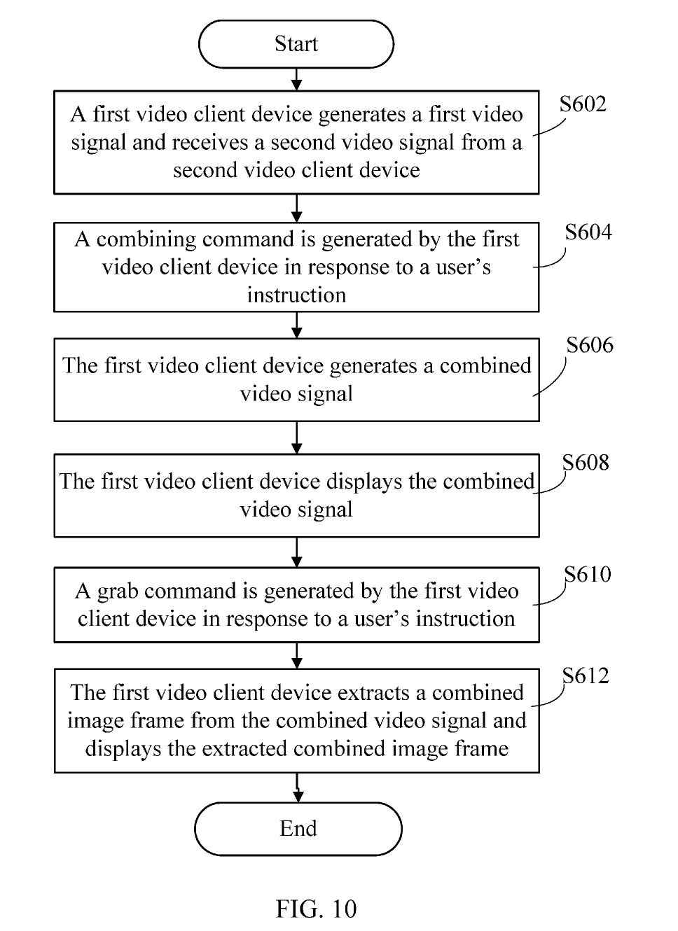

Referring to FIG. 10, a video processing method for a video system in accordance with a third exemplary embodiment is illustrated. The video processing method includes the following steps.

In step S602, a first video capture unit of a first video client device generates a first video signal, and receives a second video signal from a second video client device. The first and second video signals may be displayed on a display unit of the first video client device.

In step S604, a combining command is generated by the first video client device in response to a user's instruction. The combining command may include combining template information for instructing an image combination unit of the first video client device how to combine the first and second video signals.

In step S606, the first video client device generates a combined video signal by combining the first video signal and the second video signal. Each of combined image frames from the combined video signal includes at least a part of a first image frame from the first video signal and at least a part of a second image frame from a second video signal.

In step S608, the first video client device displays the combined video signal.

In step S610, a grab command is generated by the first video client device in response to a user's instruction.

In step S612, the first video client device extracts a combined image frame from the combined video signal, and displays the extracted combined image frame.

It is to be further understood that even though numerous characteristics and advantages of the present embodiments have been set forth in the foregoing description, together with details of the structures and functions of the embodiments, the disclosure is illustrative only; and changes may be made in detail, especially in matters of shape, size, and arrangement of parts within the principles of the present disclosure to the full extent indicated by the broad general meaning of the terms in which the appended claims are expressed.

What is claimed is:

1. A video server capable of communicating with a first video client device and a second video client device, the video server comprising:
a communication unit for receiving a first video signal from the first video client device and a second video signal from the second video client device;
an image combination unit for combining the first video signal and the second video signal to generate a combined video signal, each combined image frame from the combined video signal comprising at least a part of a first image frame from the first video signal and at least a part of a second image frame from the second video signal; and
an image frame extracting unit for extracting a combined image frame from the combined video signal in response to a grab command received from one of the first video client device and the second video client device, and sending the extracted combined image frame to the one of the first video client device and the second video client device via the communication unit.

2. The video server of claim 1, wherein the image frame extracting unit further sends the extracted combined image frame to the other of the first video client device and the second video client device via the communication unit.

3. The video server of claim 1, wherein the image combination unit combines the first video signal and the second video signal according to a combining command received from the one of the first video client device and the second video client device via the communication unit.

4. The video server of claim 3, wherein the combining command comprises combining template information for instructing the image combination unit how to combine the first and second video signals.

5. The video server of claim 1, further comprising a background change unit for replacing a predetermined part of each of the combined image frames of the combined video signal with a predetermined picture.

6. The video server of claim 5, wherein the predetermined part of each of the combined image frames has predetermined color information.

7. The video server of claim 6, wherein the predetermined color information is determined according to a background change command received from the one of the first video client device and the second video client device via the communication unit.

8. A video client device capable of communicating with a remote video client device, the video client device comprising:
a video capture unit for generating a first video signal comprising first image frames;
a communication unit for receiving a second video signal comprising second image frames from the remote video client device;
an image combination unit for combining the first video signal and the second video signal to generate a combined video signal comprising combined image frames, each combined image frame comprising at least a part of a corresponding first image frame and
at least a part of a corresponding second image frame;
an input unit for receiving a grab command;
an image frame extracting unit for extracting one of the combined image frames in response to the grab command; and
a display unit for displaying the combined image frame.

9. The video client device of claim 8, wherein the input unit further receives a combining command, and the image combination unit combines the first video signal and the second video signal according to the combining command.

10. The video client device of claim 8, further comprising a background change unit for replacing a predetermined part of each of the combined image frames with a predetermined picture according to a background change command received from the input unit.

11. The video client device of claim 10, wherein the predetermined part of each of the combined image frames has predetermined color information.

12. The video client device of claim 9, further comprising a storage unit for storing a plurality of combining templates, wherein the combining command comprises combining template information corresponding to one of the plurality of combining templates.

13. A video processing method, comprising:
receiving a first video signal from a first video capture unit;
receiving a second video signal from a second video capture unit;
combining the first video signal and the second video signal to generate a combined video signal, each combined image frame from the combined video signal comprising at least a part of a first image frame from the first video signal and at least a part of a second image frame from the second video signal;
receiving a grab command
extracting a combined image frame from the combined video signal in response to the grab command; and
displaying the extracted combined image frame on a display unit.

14. The video processing method of claim 13, wherein the first video capture unit is disposed in a first video client device, and the second video capture unit is disposed in a second video client device.

15. The video processing method of claim 14, further comprising displaying the combined video signal at respective displaying unit of the first video client device and the second video client device.

16. The video processing method of claim 13, further comprising receiving a combining command before combining the first video signal and the second video signal.

17. The video processing method of claim 13, further comprising:
receiving a background change command; and
replacing a predetermined part of each of the combined image frames with a predetermined picture according to the background change command.

18. The video processing method of claim 17, wherein the predetermined part of each of the combined image frames has predetermined color information.
